(19) United States
(12) Patent Application Publication
(10) Pub. No.: US 2026/0100655 A1
(43) Pub. Date: Apr. 9, 2026

(54) POWER MODULE, ROUTER, SWITCH, AND ELECTRONIC DEVICE

(71) Applicant: Huawei Digital Power Technologies Co., Ltd., Shenzhen (CN)

(72) Inventors: Yiwen Luo, Dongguan (CN); Ken Chin, Shenzhen (CN); Nengchao Qiu, Shenzhen (CN); Xinzhong Zhang, Dongguan (CN)

(73) Assignee: Huawei Digital Power Technologies Co., Ltd., Shenzhen (CN)

(21) Appl. No.: 19/416,539

(22) Filed: Dec. 11, 2025

Related U.S. Application Data
(63) Continuation of application No. PCT/CN2023/099702, filed on Jun. 12, 2023.

(51) Int. Cl. H02M 3/335; H02M 1/32

(52) U.S. Cl. CPC H02M 3/33576; H02M 1/32

(57) ABSTRACT

A power module includes a control circuit and a voltage conversion circuit capable of supplying power to a load. The control circuit includes a sampling and amplification circuit, a comparison circuit, and a processing circuit. The sampling and amplification circuit is configured to sample a first current output by the voltage conversion circuit, amplify the first current based on a preset coefficient, and output a second current. The comparison circuit compares the second current with a first overcurrent threshold, and outputs a first comparison signal when the second current is greater than or equal to the first overcurrent threshold. The processing circuit deactivates an output pulse signal to the voltage conversion circuit when receiving the first comparison signal, which prevents the voltage conversion circuit from overcurrent.

### CROSS-REFERENCE TO RELATED APPLICATIONS

This application is a continuation of International Application No. PCT/CN2023/099702, filed on Jun. 12, 2023, the disclosure of which is hereby incorporated by reference in its entirety.

### TECHNICAL FIELD

This application relates to the field of power electronics technologies, and in particular, to a power module, a router, a switch, and an electronic device.

### BACKGROUND

A DC-DC conversion module has advantages such as low power consumption, high efficiency, and a wide voltage regulation range, and therefore is widely used in the field of electronic technologies. In some possible scenarios, for example, if an output power of the DC-DC conversion module is very large, a problem such as overstress damage to a power element of a power module may be caused.

In some systems, an overcurrent state of a primary side is monitored by obtaining a rectifier voltage of a secondary side. If it is detected that a pulse signal is lost, it may be determined that the power element is faulty, thereby triggering overcurrent protection. However, in the foregoing systems, the overcurrent state cannot be accurately protected in a timely manner, a detected signal needs to be transmitted from the secondary side to the primary side, and consequently a system is complex. Therefore, how to accurately perform overcurrent protection on the DC-DC conversion module in a timely manner is an urgent problem that needs to be resolved currently.

### SUMMARY

This application provides a power module, a router, a switch, and an electronic device, to resolve a problem in the conventional technology that overcurrent protection cannot be accurately performed on the power module in a timely manner. In this application, security and stability of the power module can be improved, and product competitiveness can be improved.

An aspect of this application further provides a power module. The power module may include a control circuit and a voltage conversion circuit configured to supply power to a load. The control circuit is configured to control the voltage conversion circuit. The control circuit includes a sampling and amplification circuit, a comparison circuit, and a processing circuit. The sampling and amplification circuit may sample a first current output by the voltage conversion circuit, amplify the first current based on a preset coefficient, and output a second current. The comparison circuit may compare the second current with a first overcurrent threshold, and output a first comparison signal when the second current is greater than or equal to the first overcurrent threshold.

The processing circuit may stop outputting (e.g., deactivate, block, hold steady, or otherwise stop outputting) a pulse signal to the voltage conversion circuit when receiving the first comparison signal, to perform overcurrent protection on the voltage conversion circuit. According to the power module in this application, an output parameter of the voltage conversion circuit is sampled through the sampling and amplification circuit, high-precision amplification is performed on the output parameter, and an amplified output parameter is compared with a protection threshold, to implement a more accurate overcurrent protection function. In this application, a problem in the conventional technology that overcurrent protection cannot be accurately performed on the power module in a timely manner can be resolved, security and stability of the power module can be improved, and product competitiveness can be improved.

In an embodiment, the comparison circuit is further configured to: compare the second current with a second overcurrent threshold, and output a second comparison signal when the second current is greater than or equal to the second overcurrent threshold. The processing circuit is configured to output the pulse signal to the voltage conversion circuit within a first time period of one or more switching cycles, and start timing when receiving the second comparison signal at a midpoint moment of the first time period. The processing circuit stops outputting the pulse signal to the voltage conversion circuit when a timing time reaches a preset time. Based on embodiments, the control circuit in this application samples an output parameter at the midpoint moment of the time period in which a PWM signal is at a high level, and determines whether the output parameter is overcurrent, so that overcurrent protection precision is high, thereby implementing slow overcurrent protection on the power module.

In an embodiment, the comparison circuit is configured to compare the second current with a third overcurrent threshold, and output a third comparison signal when the second current is less than the third overcurrent threshold, where the third overcurrent threshold is less than the first overcurrent threshold. The processing circuit may further stop outputting the pulse signal to the voltage conversion circuit when receiving the third comparison signal. Based on embodiments, in this application, backflow current protection can be implemented on the power module, and the security and the stability of the power module can be improved.

In an embodiment, the comparison circuit may further compare the second current with a fourth overcurrent threshold, and output a fourth comparison signal when the second current is greater than or equal to the fourth overcurrent threshold. The processing circuit is further configured to stop outputting the pulse signal to the voltage conversion circuit in the one or more switching cycles when receiving the fourth comparison signal, to perform overcurrent protection on the voltage conversion circuit.

In an embodiment, the comparison circuit is configured to compare a second output parameter with a fourth threshold, and output the fourth comparison signal when the second output parameter is greater than or equal to the fourth threshold. The processing circuit is further configured to stop outputting the pulse signal to the voltage conversion circuit in the one or more switching cycles when receiving the fourth comparison signal. In such a manner, signal-by-signal current limiting protection can be implemented on the power module, and the security and the stability of the power module can be improved.

In an embodiment, the sampling and amplification circuit includes an amplifier, a first transistor, a first current source, a second current source, and a third current source. A first input end of the amplifier is connected to a first output end of the voltage conversion circuit via a first resistor. A second input end of the amplifier is connected to a second output end of the voltage conversion circuit via a second resistor. The first current source is electrically connected to the first resistor and the first input end of the amplifier. An output end of the amplifier is electrically connected to a first end of the first transistor. A second end of the first transistor is electrically connected to the second input end of the amplifier. A third end of the first transistor is electrically connected to the second current source. The third current source is grounded via a third resistor. A first node between the third current source and the third resistor is connected to the comparison circuit. The second current source and the third current source form a current mirror. In such a manner, sampling and amplification can be implemented on the output parameter of the voltage conversion circuit. In other words, in this application, high-precision amplification can be performed on a parameter such as a current.

In an embodiment, the comparison circuit may include a first comparator, a second comparator, a third comparator, and a fourth comparator. A first input end of the first comparator is connected to the first node, a second input end of the first comparator is electrically connected to the processing circuit, and an output end of the first comparator is electrically connected to the processing circuit. A first input end of the second comparator is connected to the first node, a second input end of the second comparator is electrically connected to a reference voltage generation circuit, and an output end of the second comparator is electrically connected to the processing circuit. A first input end of the third comparator is connected to the first node, a second input end of the third comparator is electrically connected to the processing circuit, and an output end of the third comparator is electrically connected to the processing circuit. A first input end of the fourth comparator is connected to the first node, a second input end of the fourth comparator is electrically connected to the processing circuit, and an output end of the fourth comparator is electrically connected to the processing circuit.

In an embodiment, the control circuit may further include a reference voltage generation circuit. The reference voltage generation circuit includes a fourth current source, a fifth current source, and a first voltage source. A first end of the first voltage source is grounded. A second end of the first voltage source is grounded via a fourth resistor. The second end of the first voltage source is further connected to a power supply via a fifth resistor. The fourth current source is grounded via a sixth resistor. Two ends of the sixth resistor are respectively connected to two ends of the fifth current source. The fifth current source is configured to receive a slope compensation reset signal. A node between the fourth current source and the sixth resistor is electrically connected to the comparison circuit.

In an aspect, an electronic device is described. The electronic device includes an input power supply and a power module. The input power supply may be configured to supply power to the power module. The power module may include a control circuit and a voltage conversion circuit configured to supply power to a load. The control circuit is configured to control the voltage conversion circuit. The control circuit may include a sampling and amplification circuit, a comparison circuit, and a processing circuit. The sampling and amplification circuit may sample a first current output by the voltage conversion circuit, amplify the first current based on a preset coefficient, and output a second current. The comparison circuit may compare the second current with a first overcurrent threshold, and output a first comparison signal when the second current is greater than or equal to the first overcurrent threshold. The processing circuit may stop outputting a pulse signal to the voltage conversion circuit when receiving the first comparison signal, to perform overcurrent protection on the voltage conversion circuit. According to the power module in this application, an output parameter of the voltage conversion circuit is sampled through the sampling and amplification circuit, high-precision amplification is performed on the output parameter, and the amplified output parameter is compared with a protection threshold, to implement a more accurate overcurrent protection function. In this application, a problem in the conventional technology that overcurrent protection cannot be accurately performed on the power module in a timely manner can be resolved, security and stability of the power module can be improved, and product competitiveness can be improved.

In an embodiment, the comparison circuit is further configured to: compare the second current with a second overcurrent threshold, and output a second comparison signal when the second current is greater than or equal to the second overcurrent threshold. The processing circuit is configured to output the pulse signal to the voltage conversion circuit within a first time period of one or more switching cycles, and start timing when receiving the second comparison signal at a midpoint moment of the first time period. The processing circuit stops outputting the pulse signal to the voltage conversion circuit when a timing time reaches a preset time. In embodiments, the control circuit in this application samples an output parameter at the midpoint moment of the time period in which a PWM signal is at a high level, and determines whether the output parameter is overcurrent, so that overcurrent protection precision is high, thereby implementing slow overcurrent protection on the power module.

In an embodiment, the comparison circuit is configured to compare the second current with a third overcurrent threshold, and output a third comparison signal when the second current is less than the third overcurrent threshold, where the third overcurrent threshold is less than the first overcurrent threshold. The processing circuit may further stop outputting the pulse signal to the voltage conversion circuit when receiving the third comparison signal. In such a manner, backflow current protection can be implemented on the power module, and the security and the stability of the power module can be improved.

In an embodiment, the comparison circuit may further compare the second current with a fourth overcurrent threshold, and output a fourth comparison signal when the second current is greater than or equal to the fourth overcurrent threshold. The processing circuit is further configured to stop outputting the pulse signal to the voltage conversion circuit in the one or more switching cycles when receiving the fourth comparison signal, to perform overcurrent protection on the voltage conversion circuit.

In an embodiment, the comparison circuit is configured to compare a second output parameter with a fourth threshold, and output the fourth comparison signal when the second output parameter is greater than or equal to the fourth threshold. The processing circuit is further configured to stop outputting the pulse signal to the voltage conversion circuit in the one or more switching cycles when receiving the fourth comparison signal. In such a manner, signal-by-signal current limiting protection can be implemented on the power module, and the security and the stability of the power module can be improved.

In an embodiment, the sampling and amplification circuit includes an amplifier, a first transistor, a first current source, a second current source, and a third current source. A first input end of the amplifier is connected to a first output end of the voltage conversion circuit via a first resistor. A second input end of the amplifier is connected to a second output end of the voltage conversion circuit via a second resistor. The first current source is electrically connected to the first resistor and the first input end of the amplifier. An output end of the amplifier is electrically connected to a first end of the first transistor. A second end of the first transistor is electrically connected to the second input end of the amplifier. A third end of the first transistor is electrically connected to the second current source. The third current source is grounded via a third resistor. A first node between the third current source and the third resistor is connected to the comparison circuit. The second current source and the third current source form a current mirror. In such a manner, sampling and amplification can be implemented on the output parameter of the voltage conversion circuit. In other words, in this application, high-precision amplification can be performed on a parameter such as a current.

In an embodiment, the comparison circuit may include a first comparator, a second comparator, a third comparator, and a fourth comparator. A first input end of the first comparator is connected to the first node, a second input end of the comparator is electrically connected to the processing circuit, and an output end of the first comparator is electrically connected to the processing circuit. A first input end of the second comparator is connected to the first node, a second input end of the second comparator is electrically connected to a reference voltage generation circuit, and an output end of the second comparator is electrically connected to the processing circuit. A first input end of the third comparator is connected to the first node, a second input end of the third comparator is electrically connected to the processing circuit, and an output end of the third comparator is electrically connected to the processing circuit. A first input end of the fourth comparator is connected to the first node, a second input end of the fourth comparator is electrically connected to the processing circuit, and an output end of the fourth comparator is electrically connected to the processing circuit.

In an embodiment, the control circuit further includes a reference voltage generation circuit. The reference voltage generation circuit includes a fourth current source, a fifth current source, and a first voltage source. A first end of the first voltage source is grounded. A second end of the first voltage source is grounded via a fourth resistor. The second end of the first voltage source is further connected to a power supply via a fifth resistor. The fourth current source is grounded via a sixth resistor. Two ends of the sixth resistor are respectively connected to two ends of the fifth current source. The fifth current source is configured to receive a slope compensation reset signal. A node between the fourth current source and the sixth resistor is electrically connected to the comparison circuit.

In an aspect, a router is described. The router may include the foregoing power module and one or more chips. The power module may be connected to the one or more chips, to supply power to the one or more chips.

In an aspect, a switch is described. The switch may include the foregoing power module and one or more chips. The power module may be connected to the one or more chips, to supply power to the one or more chips.

In embodiments of this application, the power module, the router, the switch, and the electronic device are provided, to resolve a problem in the conventional technology that overcurrent protection cannot be accurately performed on the power module in a timely manner. Multiple current protection can be implemented by using a simple circuit structure, and an accurate overcurrent protection function can be implemented, thereby improving security and stability of the power module.

### BRIEF DESCRIPTION OF DRAWINGS

FIG. 1 is a schematic of a structure of an electronic device according to this application;

FIG. 2 is a schematic of another structure of an electronic device according to this application;

FIG. 3 is a schematic of another structure of an electronic device according to this application;

FIG. 4 is a schematic of a structure of a power module according to this application;

FIG. 5 is a schematic of a structure of a sampling and amplification circuit according to this application;

FIG. 6 is a signal sequence diagram when a power module performs slow overcurrent protection;

FIG. 7 is another signal sequence diagram when a power module performs slow overcurrent protection;

FIG. 8 is a signal sequence diagram when a power module performs fast overcurrent protection;

FIG. 9 is a signal sequence diagram when a power module performs backflow current protection;

FIG. 10 is another signal sequence diagram when a power module performs backflow current protection;

FIG. 11 is a signal sequence diagram when a power module performs signal-by-signal current limiting protection;

FIG. 12 is a schematic of another structure of a power module according to this application;

FIG. 13 is a schematic of a structure of a router according to this application; and

FIG. 14 is a schematic of a structure of a switch according to this application.

### DESCRIPTION OF EMBODIMENTS

In embodiments of this application, terms such as “first” and “second” are only intended to distinguish between different objects, but should not be understood as indicating or implying relative importance, or should not be understood as indicating or implying a sequence. For example, a first application, a second application, and the like are used to distinguish between different applications, but are not used to describe a particular sequence of the applications. A feature limited to “first” and “second” may explicitly or implicitly include one or more of the features.

It should be noted that when an element is considered as “connected to” another element, the element may be directly connected to the another element, or a centrally disposed element may simultaneously exist. When an element is considered as “disposed on” another element, the element may be directly disposed on the another element, or a centrally disposed element may simultaneously exist.

Usually, in a scenario that an output power of a DC-DC conversion module is very large, a problem such as overstress damage to a power element of a power module is caused. In some solutions, an overcurrent state of a primary side is monitored by obtaining a rectifier voltage of a secondary side. If it is detected that a pulse signal is lost, it may be determined that the power element is faulty, thereby triggering overcurrent protection. However, in the foregoing solution, overcurrent protection cannot be accurately performed on the power module, a detected signal further needs to be transmitted from the secondary side to the primary side, and consequently a system is complex. Therefore, how to accurately perform overcurrent protection on the DC-DC conversion module in a timely manner is a problem that needs to be urgently resolved currently.

For the foregoing problem, embodiments of this application provide a power module, a router, a switch, and an electronic device. According to embodiments of this application, a simple and reliable current sampling manner can be used, so that more accurate overcurrent protection is implemented on the power module. This improves security and stability of the power module, and further improves product competitiveness. The following separately provides detailed descriptions by using specific embodiments.

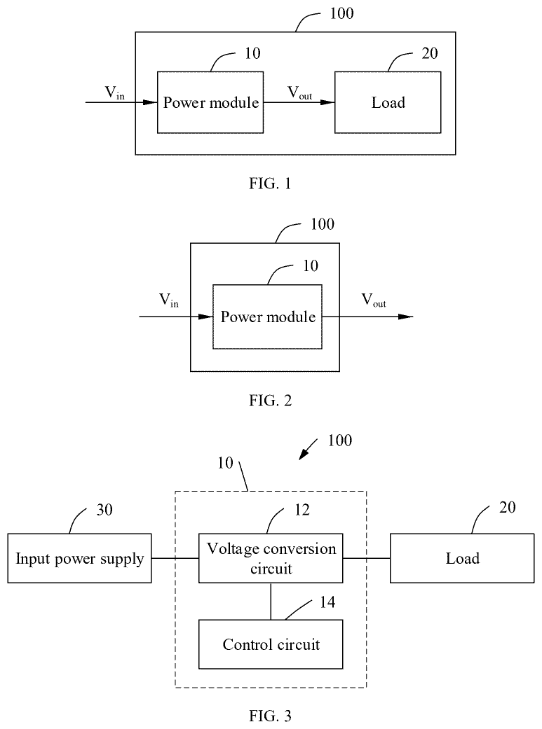

FIG. 1 is a schematic of a structure of an electronic device 100 according to an embodiment of this application.

As shown in FIG. 1, the electronic device 100 may include a power module 10 and a load 20. The power module 10 is configured to receive an input voltage Vᵢₙ, and provide an output voltage Vₒᵤₜ, to supply power to the load 20. In an embodiment, the input voltage Vᵢₙ may be provided by an external power supply, or may be provided by an internal power supply of the electronic device 100. It may be understood that the electronic device 100 provided in the embodiment shown in FIG. 1 may be a power-consuming device such as a mobile phone, a notebook computer, a computer chassis, a smart speaker, a smartwatch, or a wearable device. It may be understood that the power module 10 may be used in the electronic device 100 shown in FIG. 1.

FIG. 2 is a schematic of another structure of an electronic device 100 according to an embodiment of this application.

As shown in FIG. 2, the electronic device 100 may include a power module 10. The power module 10 may be configured to receive an input voltage Vᵢₙ, and provide an output voltage Vₒᵤₜ, to supply power to a load subsequently connected to the electronic device 100. In an embodiment, the input voltage Vᵢₙ may be provided by an external power supply, or may be provided by an internal power supply of the electronic device 100.

As shown in FIG. 2, the electronic device 100 provided in this embodiment may be a power supply device such as a power adapter, a charger, or a mobile power supply. The power module 10 provided in this embodiment of this application may be used in the electronic device 100 shown in FIG. 2.

In an embodiment of this application, the electronic device 100 may alternatively include a plurality of power modules 10, and the plurality of power modules 10 provide output voltages Vₒᵤₜ, to supply power to the load 20. In an embodiment of this application, the electronic device 100 may include a plurality of loads 20, and the power module 10 may provide a plurality of output voltages Vₒᵤₜ, to separately supply power to the plurality of loads 20. In an embodiment of this application, the electronic device 100 may include a plurality of power modules 10 and a plurality of loads 20, and the plurality of power modules 10 may provide a plurality of output voltages Vₒᵤₜ, to separately supply power to the plurality of loads 20.

In an embodiment of this application, the input voltage Vᵢₙ may be an alternating current, and the power module 10 may include an alternating current-to-direct current conversion circuit. In this embodiment of this application, the input voltage Vᵢₙ may be a direct current, the internal power supply may include an energy storage apparatus, and the power module 10 may include a direct current conversion circuit. Correspondingly, when the electronic device 100 operates independently, the energy storage apparatus of the internal power supply may supply power to the power module 10.

In an embodiment of this application, the input voltage Vᵢₙ may be a direct current. The load 20 of the electronic device 100 may include one or more of a power-consuming apparatus, an energy storage apparatus, or an external device. In an embodiment, the load 20 may be a power-consuming apparatus of the electronic device 100, for example, a processor or a display. In an embodiment, the load 20 may be an energy storage apparatus of the electronic device 100, for example, a battery. In an embodiment, the load 20 may be an external device of the electronic device 100, for example, another electronic device such as a display or a keyboard.

The following describes in detail an internal structure of the power module.

FIG. 3 is a schematic of a structure of an electronic device 100 according to an embodiment of this application.

In an example, the electronic device 100 may include a power module 10, a load 20, and an input power supply 30. The power module 10 is electrically connected between the input power supply 30 and the load 20. The power module 10 in this embodiment may include a voltage conversion circuit 12 and a control circuit 14.

The voltage conversion circuit 12 may be connected between the input power supply 30 and the load 20. It may be understood that the voltage conversion circuit 12 may be configured to receive an input voltage of the input power supply 30 and provide an output voltage for the load 20. For example, the voltage conversion circuit 12 may convert the input voltage of the input power supply 30, and provide the output voltage to the load 20, to supply power to the load 20.

In this embodiment, the control circuit 14 may be configured to be electrically connected to the voltage conversion circuit 12, and may be configured to obtain an output parameter of the voltage conversion circuit 12.

In some application scenarios, the control circuit 14 may be further configured to process the output parameter of the voltage conversion circuit 12, and correspondingly output a pulse width modulation (PWM) signal to the voltage conversion circuit 12.

In some possible embodiments, the input power supply 30 may be a 48 V power supply.

For example, the input power supply 30 may output a first voltage to the voltage conversion circuit 12, so that the voltage conversion circuit 12 may convert the first voltage into a second voltage. It may be understood that in some possible application scenarios, the first voltage may be a 48 V direct current voltage. The second voltage may be a 12 V direct current voltage. In other words, the voltage conversion circuit 12 may convert a 48 V direct current voltage input by the input power supply 30 into a 12 V direct current voltage. The voltage conversion circuit 12 may output the 12 V direct current voltage obtained through conversion to the load 20, to supply power to the load 20.

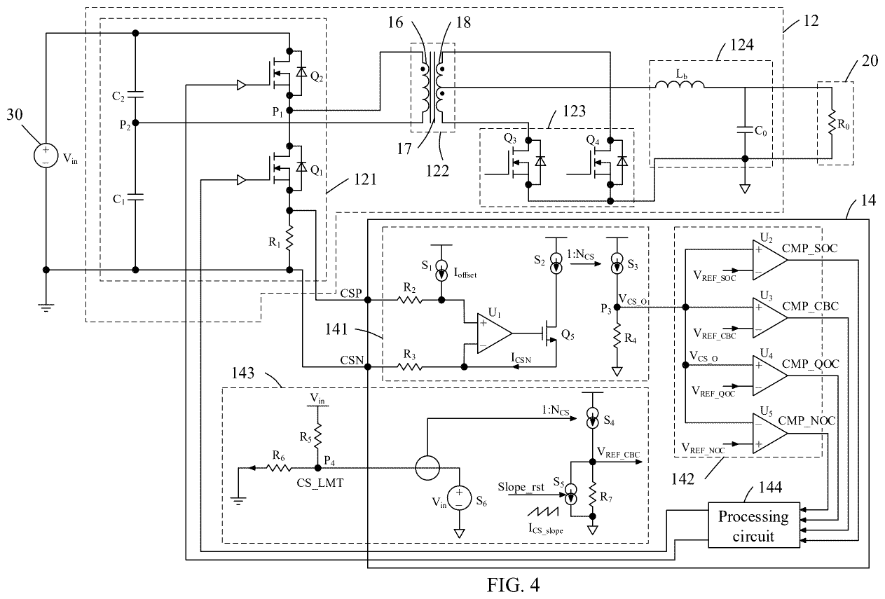

FIG. 4 is a schematic of a structure of a power module 10 according to an embodiment of this application.

In this embodiment, a voltage conversion circuit 12 may include a power stage circuit 121, a transformer 122, and a rectifier circuit 123.

The power stage circuit 121 in this embodiment is a half-bridge circuit. To be specific, the power stage circuit 121 may include a switching transistor Q₁ and a switching transistor Q₂.

It may be understood that a control circuit 14 may send control signals to the switching transistor Q₁ and the switching transistor Q₂, so that the switching transistor Q₁ and the switching transistor Q₂ may be turned on or off based on the received control signals. A first end of the switching transistor Q₂ is connected to a first output end of an input power supply 30, a second end of the switching transistor Q₂ is connected to a first end of the switching transistor Q₁, and a second end of the switching transistor Q₁ is connected to a second output end of the input power supply 30 and a reference ground via a resistor R₁. A third end of the switching transistor Q₂ is a control end of the switching transistor Q₂. In other words, the third end of the switching transistor Q₂ may be configured to receive the control signal sent by the control circuit 14. A third end of the switching transistor Q₁ is a control end of the switching transistor Q₁. In other words, the third end of the switching transistor Q₁ may be configured to receive the control signal of the control circuit 14.

In this embodiment, the first end of the switching transistor Q₂ may be further connected to a first end of a bus capacitor C₂, a second end of the bus capacitor C₂ may be connected to a first end of a bus capacitor C₁, and a second end of the bus capacitor C₁ may be further connected to the second end of the switching transistor Q₁ via the resistor R₁.

The power stage circuit 121 may be configured to receive an input voltage Vᵢₙ, and provide an output voltage for a primary-side winding 16 of the transformer 122 based on the control signal provided by the control circuit 14. The transformer 122 includes the primary-side winding 16, a secondary-side winding 18, and a magnetic core 17. The secondary-side winding 18 of the transformer 122 is coupled to the primary-side winding 16 via the magnetic core 17. The primary-side winding 16 of the transformer 122 is configured to receive the output voltage of the power stage circuit 121, and may generate a primary-side winding voltage. The secondary-side winding 18 of the transformer 122 is coupled to the primary-side winding 16, and a secondary-side winding voltage may be generated on the secondary-side winding 18. It may be understood that the primary-side winding may be a winding placed at a primary stage of the transformer. The secondary-side winding may be a winding placed at a secondary stage of the transformer.

A first end of the primary-side winding 16 is electrically connected to a node P₁ between the second end of the switching transistor Q₂ and the first end of the switching transistor Q₁, and a second end of the primary-side winding 16 is electrically connected to a node P₂ between the second end of the capacitor C₂ and the first end of the capacitor C₁.

The rectifier circuit 123 may be configured to receive the secondary-side winding voltage on the secondary-side winding 18, and convert the secondary-side winding voltage into an output voltage V₁ to a filter circuit 124. The filter circuit 124 may be configured to filter the output voltage V₁, and provide an output voltage Vₒᵤₜ obtained through filtering for a load 20.

The rectifier circuit 123 may include a switching transistor Q₃ and a switching transistor Q₄. A first end of the switching transistor Q₃ is electrically connected to a first end of the secondary-side winding 18, a second end of the switching transistor Q₃ is electrically connected to a second end of the switching transistor Q₄, and a first end of the switching transistor Q₄ is electrically connected to a second end of the secondary-side winding 18. A third end of the switching transistor Q₃ is a control end of the switching transistor Q₃. In other words, the third end of the switching transistor Q₃ may be configured to receive the control signal sent by the control circuit 14. A third end of the switching transistor Q₄ is a control end of the switching transistor Q₄. In other words, the third end of the switching transistor Q₄ may be configured to receive the control signal of the control circuit 14.

It may be understood that the switching transistors Q₁ to Q₄ may be metal-oxide-semiconductor field-effect transistors (MOSFETs), insulated gate bipolar transistors (IGBTs), bipolar power transistors, wide-bandgap semiconductor field-effect transistors, or the like.

The filter circuit 124 may include an inductor L_{b} and a capacitor Cₒ. A first end of the inductor L_{b} may be electrically connected to a midpoint of the secondary-side winding 18, a second end of the inductor L_{b} may be electrically connected to a first end of the capacitor Cₒ and a first end of the load 20, a second end of the capacitor Cₒ may be grounded, and the second end of the capacitor Cₒ is further electrically connected to the second end of the switching transistor Q₃, the second end of the switching transistor Q₄, and a second end of the load 20.

In this embodiment, the control circuit 14 may be electrically connected to an output end of the power stage circuit 121. The control circuit 14 may sample the output voltage or an output current of the power stage circuit 121.

Specifically, the control circuit 14 may include a sampling and amplification circuit 141, a comparison circuit 142, a reference voltage generation circuit 143, and a processing circuit 144.

The sampling and amplification circuit 141 is electrically connected to the voltage conversion circuit 12 and the comparison circuit 142. The comparison circuit 142 is electrically connected to the processing circuit 144 and the reference voltage generation circuit 143. The sampling and amplification circuit 141 may sample an output parameter of the voltage conversion circuit 12, amplify the output parameter based on a preset coefficient, and output an amplified parameter. For example, the output parameter may be an output current of the voltage conversion circuit 12. In a possible example, the sampling and amplification circuit 141 may sample the output current of the power stage circuit 121, and output a corresponding sampling signal to the comparison circuit 142 based on the sampled output current.

The sampling and amplification circuit 141 may include an amplifier U₁, a transistor Q₅, current sources S₁ to S₃, and resistors R₂ to R₄.

A first input end of the amplifier U₁ is connected to a first end of the resistor R₁ via the resistor R₂, and a second input end of the amplifier U₁ is connected to a second end of the resistor R₁ via the resistor R₃. The current source S₁ is electrically connected to the resistor R₂ and the first input end of the amplifier U₁. An output end of the amplifier U₁ is electrically connected to a first end of the transistor Q₅, and a second end of the transistor Q₅ is electrically connected to the second input end of the amplifier U₁ and the resistor R₃. A third end of the transistor Q₅ is electrically connected to the current source S₂. The current source S₃ is grounded via the resistor R₄. The current source S₂ and the current source S₃ may form a 1:N_{cs} current mirror. A node P₃ between the current source S₃ and the resistor R₄ may be connected to the comparison circuit 142, and the node P₃ may output a voltage V_{CS_O} to the comparison circuit 142.

It may be understood that the transistor Q₅ may be a MOS transistor or a triode.

The sampling and amplification circuit 141 is electrically connected to the two ends of the resistor R₁, and the sampling and amplification circuit 141 may sample a current I₁ of the switching transistor Q₁ by sampling a current that passes through the resistor R₁.

For example, it is assumed that a resistance value of the resistor R₁ is r1, a resistance value of the resistor R₂ is r2, a resistance value of the resistor R₃ is r3, a resistance value of the resistor R₄ is r4, and a current output by the current source S₁ is I_{offset}. It may be understood that the resistance value r2 of the resistor R₂ is far greater than the resistance value r1 of the resistor R₁. According to a basic working principle of an operational amplification circuit, it can be learned that the voltage V_{CS_O} output by the node P₃ may satisfy the following formula (1):

$${V}_{CS \_ O} = \frac{{I}_{1} \times r 1 + {I}_{offset} \times r 2}{r 3} \times {N}_{CS} \times r 4 \qquad ( 1 )$$

V_{CS_O} is the voltage output by the node P₃, and N_{cs} is a ratio coefficient of the current mirror formed by the current source S₂ and the current source S₃.

It may be understood that, in some more specific application scenarios, the resistance value r2 of the resistor R₂ may be close to or equal to the resistance value r3 of the resistor R₃. Therefore, the voltage V_{CS_O} output by the node P₃ may further satisfy the following formula (2):

$${V}_{CS \_ O} = {I}_{1} \times k 1 + {V}_{offset} \qquad ( 2 )$$

The bias voltage V_{offset} in the foregoing formula (2) may satisfy the following formula (3), and k1 may satisfy the following formula (4):

$${V}_{offset} = {I}_{offset} \times {N}_{CS} \times r 4 \qquad ( 3 )$$

$$k 1 = \frac{r 1 \times {N}_{CS} \times r 4}{r 3} \qquad ( 4 )$$

It can be learned from the foregoing formulas (1) to (4) that the sampling and amplification circuit 141 may obtain a second current by sampling the current I₁ of the switching transistor Q₁ and amplifying the sampled current I₁ in a proportion of the preset coefficient k1, that is, obtain a voltage V_{CS_O} related to the current I₁ of the switching transistor Q₁. In such a manner, the control circuit 14 in this application may obtain, through sampling through the sampling and amplification circuit 141, a voltage related to the current I₁ of the switching transistor Q₁.

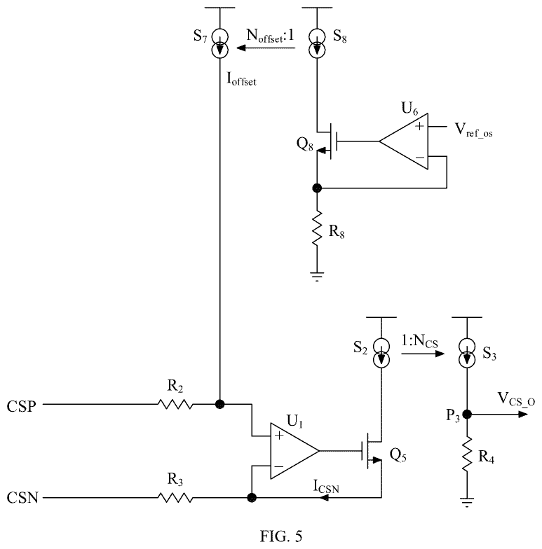

FIG. 5 is a schematic of another structure of a sampling and amplification circuit according to an embodiment of this application.

A difference from the sampling and amplification circuit shown in the embodiment in FIG. 4 lies in that, as shown in FIG. 5, in this embodiment, the sampling and amplification circuit 141 may further include an amplifier U₆, a transistor Q₈, current sources S₇ and S₈, and a resistor R₈.

It may be understood that the transistor Q₈ may be a MOS transistor or a triode.

A first input end of the amplifier U₆ is connected to the processing circuit 144, a second input end of the amplifier U₆ is grounded via the resistor R₈, an output end of the amplifier U₆ is connected to a first end of the transistor Q₈, a second end of the transistor Q₈ is grounded via the resistor R₈, and a third end of the transistor Q₈ is connected to the current source S₈. The current source S₇ is electrically connected to the resistor R₂ and the first input end of the amplifier U₁. The current source S₈ and the current source S₇ may form a 1:N_{offset} current mirror.

For example, it is assumed that a resistance value of the resistor R₈ is r8, and a voltage received by the first input end of the amplifier U₆ is V_{ref_os}. It can be learned from the basic working principle of the operational amplification circuit that, the voltage V_{CS_O} output by the node P₃ may satisfy the following formula (5):

$${V}_{CS \_ O} = {V}_{CS} \times {N}_{CS} \times \frac{r 4}{r 3} + {V}_{ref \_ os} \times {N}_{offset} \times {N}_{CS} \times \frac{r 2}{r 3} \times \frac{r 4}{r 8} \qquad ( 5 )$$

V_{CS_O} is the voltage output by the node P₃, N_{cs} is the ratio coefficient of the current mirror formed by the current source S₂ and the current source S₃, and N_{offset} is a ratio coefficient of a current mirror formed by the current source S₇ and the current source S₈.

It may be understood that, in this embodiment, R₂, R₃, R₄, and R₈ match each other, and an amplification multiple and a bias are affected only by a voltage reference, a current mirror ratio, and a resistor ratio, so that precision can be ensured. Therefore, high-precision amplification can be performed on a current of the switching transistor Q₁. This improves current sampling precision.

Refer to FIG. 4 again. The reference voltage generation circuit 143 may include resistors R₅ to R₇, current sources S₄ and S₅, and a voltage source S₆.

A first end of the resistor R₅ is connected to a power supply Vᵢₙ, a second end of the resistor R₅ is grounded via the resistor R₆, and a node P₄ between the resistor R₅ and the resistor R₆ may be grounded via the voltage source S₆. The current source S₄ is grounded via the resistor R₇, and two ends of the resistor R₇ are respectively connected to the two ends of the current source S₅. It may be understood that the current source S₅ in this embodiment is a slope current source, and the current source S₅ may generate a current slope signal. The current source S₅ may receive a slope compensation reset signal slope_rst. A node P₅ between the current source S₄ and the resistor R₇ is electrically connected to the comparison circuit 142, to output a reference signal V_{REF_CBC} to the comparison circuit 142.

In this embodiment, the comparison circuit 142 may include a comparator U₂, a comparator U₃, a comparator U₄, and a comparator U₅.

A first input end of the comparator U₂ may be connected to the node P₃ between the current source S₃ and the resistor R₄, to receive the voltage V_{CS_O} output by the node P₃. A second input end of the comparator U₂ is electrically connected to the processing circuit 144, to receive a reference signal V_{REF_SOC} output by the processing circuit 144. An output end of the comparator U₂ is electrically connected to the processing circuit 144. The comparator U₂ may compare the voltage V_{CS_O} with the reference signal V_{REF_SOC}, to output a first comparison signal CMP_SOC to the processing circuit 144.

A first input end of the comparator U₃ may be connected to the node P₃ between the current source S₃ and the resistor R₄, to receive the voltage V_{CS_O} output by the node P₃. A second input end of the comparator U₃ is electrically connected to the reference voltage generation circuit 143, to receive the reference signal V_{REF_CBC} output by the reference voltage generation circuit 143. An output end of the comparator U₃ is electrically connected to the processing circuit 144, and the comparator U₃ may compare the voltage V_{CS_O} with the reference signal V_{REF_CBC}, to output a second comparison signal CMP_CBC to the processing circuit 144.

A first input end of the comparator U₄ may be connected to the node P₃ between the current source S₃ and the resistor R₄, to receive the voltage V_{CS_O} output by the node P₃. A second input end of the comparator U₄ is electrically connected to the processing circuit 144, to receive a reference signal V_{REF_QOC} output by the processing circuit 144. An output end of the comparator U₄ is electrically connected to the processing circuit 144, and the comparator U₄ may compare the voltage V_{CS_O} with the reference signal V_{REF_QOC}, to output a third comparison signal CMP_QOC to the processing circuit 144.

A first input end of the comparator U₅ may be connected to the node P₃ between the current source S₃ and the resistor R₄, to receive the voltage V_{CS_O} output by the node P₃. A second input end of the comparator U₅ is electrically connected to the processing circuit 144, to receive a reference signal V_{REF_NOC} output by the processing circuit 144. An output end of the comparator U₅ is electrically connected to the processing circuit 144, and the comparator U₅ may compare the voltage V_{CS_O} with the reference signal V_{REF_NOC}, to output a fourth comparison signal CMP_NOC to the processing circuit 144.

The comparison circuit 142 receives the voltage V_{CS_O} output by the sampling and amplification circuit 141, and correspondingly outputs a comparison signal to the processing circuit 144. The processing circuit 144 may control a status of the voltage conversion circuit 12 based on the received comparison signal, to implement overcurrent protection on the voltage conversion circuit 12. Examples are used below for description with reference to possible application scenarios.

### 1. Slow Overcurrent Protection Scenario:

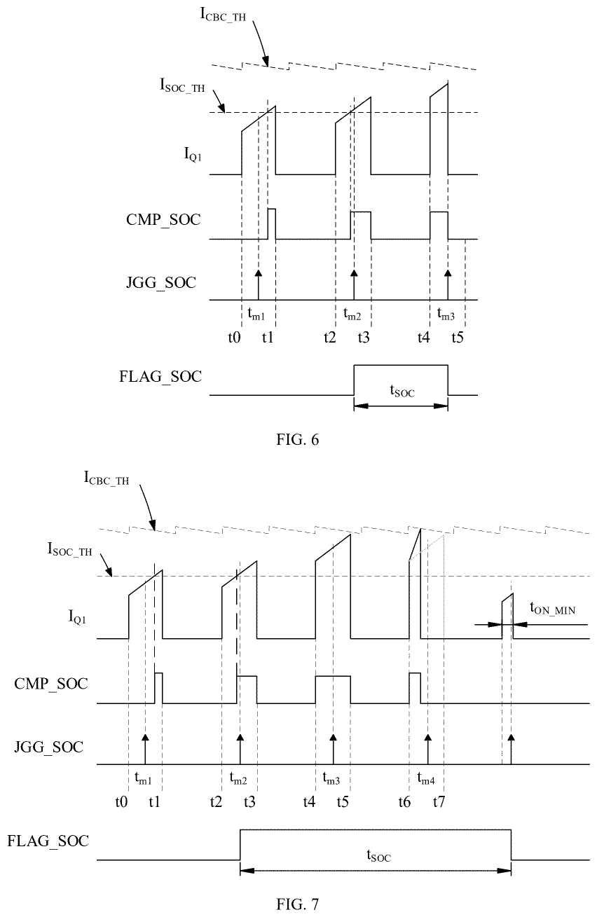

As shown in FIG. 6, I_{Q1} is a current of the switching transistor Q₁, and CMP_SOC is a first comparison signal output by the comparator U₂. The processing circuit 144 may sample a first comparison signal CMP_SOC when the switching transistor Q₁ is at a midpoint of a pulse signal. If a current I_{Q1} of the switching transistor Q₁ at the midpoint of the pulse signal is greater than a current threshold I_{SOC_TH}, the first comparison signal CMP_SOC is at a high level. In this case, the processing circuit 144 may start to perform overcurrent timing. If a timing time t_{SOC} is greater than or equal to a preset time t_{SOC_DELAY}, the processing circuit 144 may determine that the voltage conversion circuit 12 is in an overcurrent state. That is, the processing circuit 144 stops outputting the pulse signal to the voltage conversion circuit 12, and enters a hiccup state. If a timing time t_{SOC} is less than a preset time t_{SOC_DELAY}, the timing time is reset.

For example, within a time period from t0 to t1, the processing circuit 144 outputs the pulse signal to the switching transistor Q₁. tₘ₁ is a midpoint moment between the moment t0 and the moment t1. The processing circuit 144 may sample a first comparison signal CMP_SOC of the switching transistor Q₁ at the moment tₘ₁. As shown in FIG. 6, a current I_{Q1} of the switching transistor Q₁ at the moment tₘ₁ is less than the current threshold I_{SOC_TH}, and the first comparison signal CMP_SOC is at a low level. The processing circuit 144 does not perform overcurrent timing. Within the time period from t0 to t1, when the current I_{Q1} of the switching transistor Q₁ is greater than or equal to the current threshold I_{SOC_TH}, the comparator U₂ outputs a high-level first comparison signal CMP_SOC to the processing circuit 144.

Within a time period from t1 to t2, the processing circuit 144 does not output the pulse signal to the switching transistor Q₁, so that the switching transistor Q₁ stops outputting the current.

The time period from t0 to t1 and the time period from t1 to t2 are a switching cycle T.

Within a time period from t2 to t3, the processing circuit 144 outputs the pulse signal to the switching transistor Q₁. tm2 is a midpoint moment between the moment t2 and the moment t3. The processing circuit 144 may sample a first comparison signal CMP_SOC of the switching transistor Q₁ at the moment tₘ₂. As shown in FIG. 6, a current I_{Q1} of the switching transistor Q₁ at the moment tₘ₂ is greater than or equal to the current threshold I_{SOC_TH}, and the processing circuit 144 may sample the high-level first comparison signal CMP_SOC. The processing circuit 144 starts to perform overcurrent timing. Within the time period from t2 to t3, when the current I_{Q1} of the switching transistor Q₁ is greater than or equal to the current threshold I_{SOC_TH}, the comparator U₂ outputs the high-level first comparison signal CMP_SOC to the processing circuit 144.

Within a time period from t3 to t4, the processing circuit 144 does not output the pulse signal to the switching transistor Q₁, so that the switching transistor Q₁ stops outputting the current.

The time period from t2 to t3 and the time period from t3 to t4 are a switching cycle T.

Within a time period from t4 to t5, the processing circuit 144 outputs the pulse signal to the switching transistor Q₁. tm3 is a midpoint moment between the moment t4 and the moment t5. The processing circuit 144 may sample a current I_{Q1} of the switching transistor Q₁ at the moment tm3. As shown in FIG. 6, the current I_{Q1} of the switching transistor Q₁ at the moment tm3 is greater than or equal to the current threshold I_{SOC_TH}, and the processing circuit 144 may sample the high-level first comparison signal CMP_SOC. In this case, the timing time t_{SOC} is greater than or equal to t_{SOC_DELAY}, and the Processing Circuit 144 May Determine that the Voltage Conversion circuit 12 is in a slow overcurrent state. That is, the processing circuit 144 stops outputting the pulse signal to the voltage conversion circuit 12, and enters the hiccup state.

It may be understood that, a current, at a midpoint in which the pulse signal is at a high level, sampled in this application does not change with the input voltage Vᵢₙ. Therefore, in this application, accurate output current monitoring can be implemented without compensating the input voltage Vᵢₙ.

In a scenario, as shown in FIG. 7, within a time period from t6 to t7, tₘ₄ is a midpoint moment between the moment t6 and the moment t7. If the current of the switching transistor Q₁ is triggered to a current threshold I_{CBC_TH}, a duty cycle of the pulse signal decreases, and the processing circuit 144 cannot sample overcurrent information. The processing circuit 144 may determine that the current of the switching transistor Q₁ is still greater than the current threshold I_{SOC_TH}. In another scenario, when the duty cycle of the pulse signal is output by using small pulse width, to avoid noise interference, a midpoint moment of a time period in which the pulse signal is at a high level needs to be adjusted to a moment after a blanking time.

Based on the control circuit in this embodiment of this application, a current midpoint may be used as an overcurrent protection point, and overcurrent protection precision is high, so that overcurrent protection can be accurately performed on the power module in a timely manner. This improves security and stability of the power module.

### 2. Fast Overcurrent Protection Scenario:

In some possible scenarios, when a short-circuit working condition occurs in the power module, the control circuit may output a pulse signal with a minimum duty cycle. In this case, the pulse signal cannot limit a current rise of the inductor L_{b}. In other words, a current of the inductor L_{b} exceeds a safe range. Consequently, this further causes a security risk.

Therefore, the control circuit 14 provided in this application may compare a sampled current with an overcurrent protection threshold (namely, a current threshold I_{QOC_TH}). The current threshold I_{QOC_TH} is a fast overcurrent protection threshold greater than a signal-by-signal current limiting threshold I_{CBC_TH}.

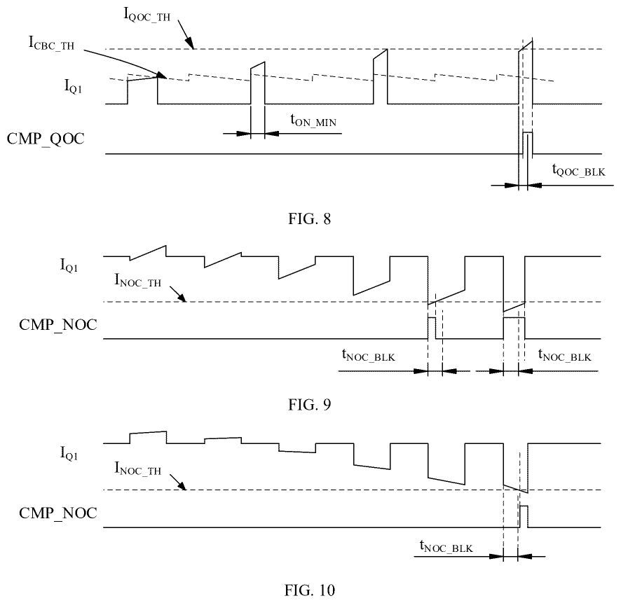

As shown in FIG. 8, I_{Q1} is a current of the switching transistor Q₁, and CMP_QOC is a third comparison signal output by the comparator U₄. When the current I_{Q1} sampled by the control circuit 14 is greater than or equal to the current threshold I_{QOC_TH}, the processing circuit 144 may detect that the comparator U₄ outputs a high-level third comparison signal CMP_QOC.

As shown in FIG. 8, after a leading-edge blanking time t_{QOC_BLK} ends, the processing circuit 144 stops outputting the pulse signal, to enter the hiccup state. In this way, the current of the inductor L_{b} may be limited to continue to rise, and an overcurrent of the voltage conversion circuit 12 is protected.

### 3. Backflow Current Protection Scenario:

In some possible scenarios, for example, when there is backflow of the current output by the switching transistor Q₁, the current of the inductor L_{b} reverses. If a reverse current of the inductor L_{b} continuously increases, a circuit cannot clamp a voltage when rectifier transistors (such as the switching transistor Q₃ and the switching transistor Q₄) are turned off.

For example, in a scenario, when an output residual voltage of a system is very high, a duty cycle of the switching transistor Q₁ starts from 0 and increases slowly. If a slow-spread speed of duty cycles of the rectifier transistors (namely, the switching transistor Q₃ and the switching transistor Q₄) is fast, freewheeling time of the rectifier transistors is excessively long, and consequently, the current of the inductor L_{b} is reversely increased, thereby forming a backflow current. In another scenario, if the input voltage Vᵢₙ quickly drops from a high voltage to a low voltage, the duty cycle of the switching transistor Q₁ spreads slowly, and the freewheeling time of the rectifier transistors is longer than that in a steady state. As a result, the current of the inductor L_{b} is smaller than that in the steady state, and even a backflow phenomenon occurs.

As shown in FIG. 9, I_{Q1} is a current of the switching transistor Q₁, and CMP_NOC is a fourth comparison signal output by the comparator U₅. When a backflow current of the switching transistor Q₁ is less than the current threshold I_{NOC_TH}, the processing circuit 144 may detect that the comparator U₅ outputs a high-level fourth comparison signal CMP_NOC. After a leading-edge blanking time I_{NOC_BLK} ends, the processing circuit 144 turns off all the switching transistors Q₁ to Q₄ and enters the hiccup state, to reduce the reverse current of the inductor L_{b}, and protect the overcurrent of the voltage conversion circuit 12.

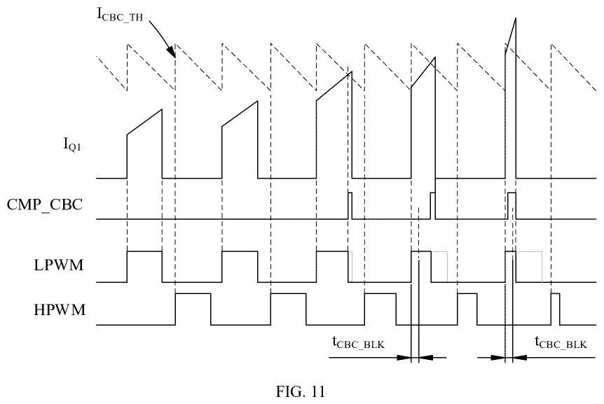

It may be understood that, in another possible scenario, when the input voltage Vᵢₙ is less than the output voltage Vₒᵤₜ, and the rectifier transistors (such as the switching transistor Q₃ and the switching transistor Q₄) are turned on, the current of the inductor L_{b} increases negatively. As shown in FIG. 10, when the backflow current of the switching transistor Q₁ is less than the current threshold I_{NOC_TH}, the processing circuit 144 may detect that the comparator U₅ outputs the high-level fourth comparison signal CMP_NOC. The processing circuit 144 needs to stop outputting the pulse signal to the switching transistors Q₁ to Q₄. After the leading-edge blanking time I_{NOC_BLK} ends, the processing circuit 144 turns off all the switching transistors Q₁ to Q₄ and enters the hiccup state, to reduce the reverse current of the inductor L_{b}, and protect the overcurrent of the voltage conversion circuit 12.

### 4. Signal-by-Signal Current Limiting Protection Scenario:

As shown in FIG. 11, I_{Q1} is a current of the switching transistor Q₁, CMP_CBC is a second comparison signal output by the comparator U₃, LPWM is a pulse signal output by the processing circuit 144 to the switching transistor Q₁, and HPWM is a pulse signal output by the processing circuit 144 to the switching transistor Q₂. If the current I_{Q1} of the switching transistor Q₁ is greater than or equal to the current threshold I_{CBC_TH}, and the comparator U₃ outputs a high-level second comparison signal CMP_CBC to the processing circuit 144 after the blanking time t_{CBC_BLK} ends, the processing circuit 144 stops outputting the pulse signal to all the switching transistors Q₁ to Q₄ in one switching cycle until a next switching cycle starts. It may be understood that, to ensure magnetic balance of the transformer 122, pulse matching needs to be performed on pulse signals output to the switching transistor Q₁ and the switching transistor Q₂.

Based on embodiments, multiple current protection such as slow overcurrent protection, fast overcurrent protection, backflow current protection, and signal-by-signal current limiting protection can be implemented without adding an IC port. In this application, a simpler peripheral circuit is used, to implement more current protection functions.

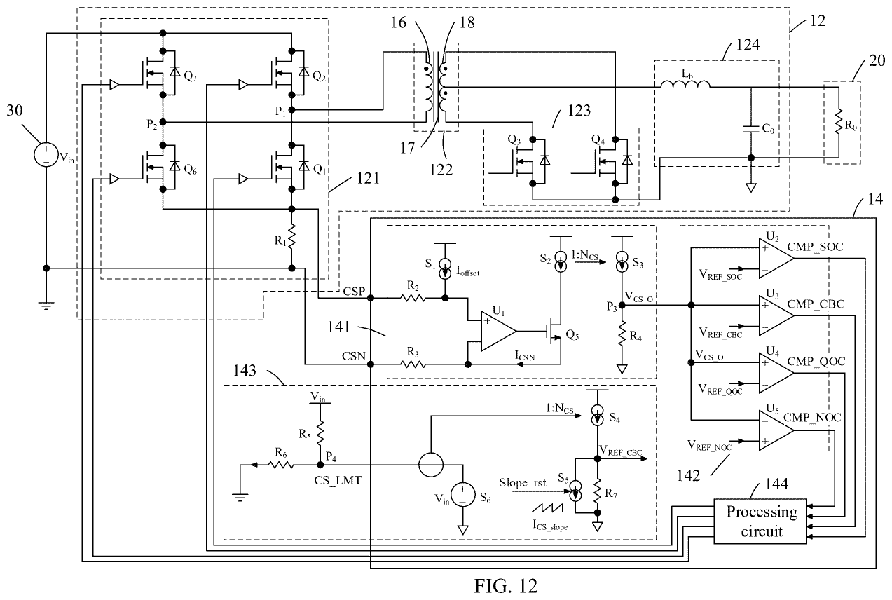

FIG. 12 is a schematic of a structure of a power module 10 according to another embodiment of this application.

A difference from the power module 10 shown in the embodiment in FIG. 4 lies in that, in this embodiment, as shown in FIG. 12, a power stage circuit 121 is a full-bridge circuit. That is, the power stage circuit 121 may include a switching transistor Q₁, a switching transistor Q₂, a switching transistor Q₆, and a switching transistor Q₇.

A first end of the switching transistor Q₂ is connected to a first output end of an input power supply 30, a second end of the switching transistor Q₂ is connected to a first end of the switching transistor Q₁, and a second end of the switching transistor Q₁ is connected to a second output end of the input power supply 30 and a reference ground via a resistor R₁. A third end of the switching transistor Q₁ is connected to a processing circuit 144, and a third end of the switching transistor Q₂ is connected to the processing circuit 144. The third end of the switching transistor Q₂ is a control end of the switching transistor Q₂. The third end of the switching transistor Q₁ is a control end of the switching transistor Q₁.

A first end of the switching transistor Q₇ is connected to the first output end of the input power supply 30, a second end of the switching transistor Q₇ is connected to a first end of the switching transistor Q₆, a second end of the switching transistor Q₆ is connected to the second end of the switching transistor Q₁, and a node P₂ between the second end of the switching transistor Q₇ and the first end of the switching transistor Q₆ is connected to a second end of a primary-side winding 16. A third end of the switching transistor Q₇ is connected to the processing circuit 144, and a third end of the switching transistor Q₆ is connected to the processing circuit 144. The third end of the switching transistor Q₇ is a control end of the switching transistor Q₇. The third end of the switching transistor Q₆ is a control end of the switching transistor Q₆.

It may be understood that an embodiment of this application further provides a communication device. The communication device may be but is not limited to a router, a switch, or the like. The communication device may include the power module in the foregoing embodiments, and the power module may supply power to a load in the communication device.

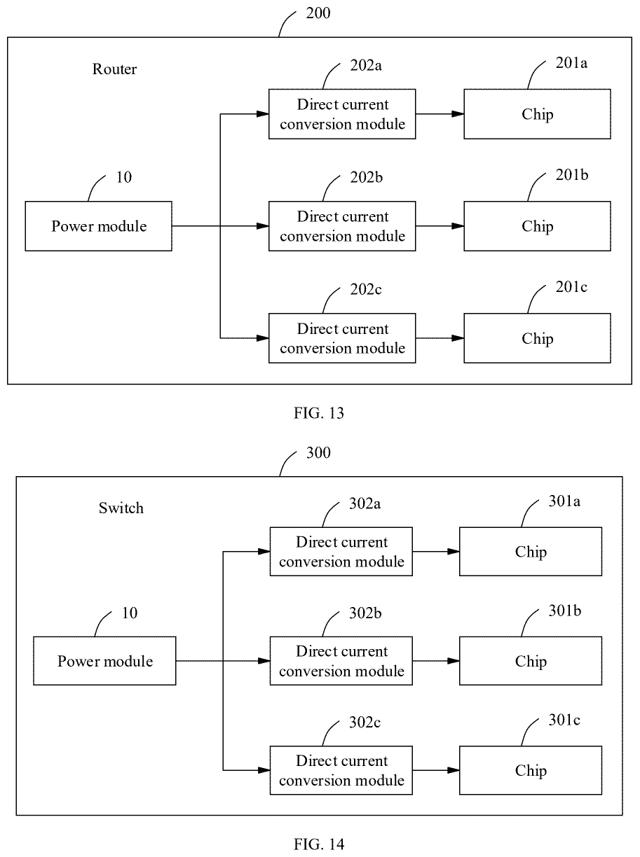

Refer to FIG. 13. An embodiment of this application further provides a router 200. The router 200 may include one or more chips and the power module described in the foregoing embodiments. The power module may be configured to supply power to the one or more chips. In an example, the router 200 may include a plurality of chips 201a, 201b, 201c, and a power module 10. The power module 10 may be electrically connected to an input power supply. The power module 10 may convert a first voltage input by the input power supply into a second voltage, to supply power to the plurality of chips 201a, 201b, and 201c. The first voltage may be a 48 V direct current voltage. The second voltage may be a 12 V direct current voltage. The power module 10 may convert a 48 V direct current voltage input by the input power supply into a 12 V direct current voltage, to supply power to the plurality of chips 201a, 201b, and 201c.

It may be understood that, in another possible application scenario, the router 200 may further include a plurality of direct current conversion circuits 202a, 202b, and 202c. The plurality of direct current conversion circuits 202a, 202b, and 202c are in a one-to-one correspondence with and electrically connected to the plurality of chips 201a, 201b, and 201c. The direct current conversion circuit 202a is electrically connected between an output end of the power module 10 and the chip 201a. The direct current conversion circuit 202b is electrically connected between the output end of the power module 10 and the chip 201b. The direct current conversion circuit 202c is electrically connected between the output end of the power module 10 and the chip 201c. The direct current conversion circuit 202a is configured to convert a voltage output by the power module 10 into a voltage required by the chip 201a. The direct current conversion circuit 202b is configured to convert the voltage output by the power module 10 into a voltage required by the chip 201b. The direct current conversion circuit 202c is configured to convert the voltage output by the power module 10 into a voltage required by the chip 201c.

Refer to FIG. 14. An embodiment of this application further provides a switch 300. The switch 300 may include one or more chips and the power module described in the foregoing embodiments. The power module may be configured to supply power to the one or more chips. In an example, the switch 300 may include a plurality of chips 301a, 301b, 301c, and a power module 10. The power module 10 may be electrically connected to an input power supply. The power module 10 may convert a first voltage input by the input power supply into a second voltage, to supply power to the plurality of chips 301a, 301b, and 301c. The power module 10 may convert a 48 V direct current voltage input by the input power supply into a 12 V direct current voltage, to supply power to the plurality of chips 301a, 301b, and 301c.

It may be understood that, in another possible application scenario, the switch 300 may further include a plurality of direct current conversion circuits 302a, 302b, and 302c. The plurality of direct current conversion circuits 302a, 302b, and 302c are in a one-to-one correspondence with and electrically connected to the plurality of chips 301a, 301b, and 301c. The direct current conversion circuit 302a is electrically connected between an output end of the power module 10 and the chip 301a. The direct current conversion circuit 302b is electrically connected between the output end of the power module 10 and the chip 301b. The direct current conversion circuit 302c is electrically connected between the output end of the power module 10 and the chip 301c. The direct current conversion circuit 302a is configured to convert a voltage output by the power module 10 into a voltage required by the chip 301a. The direct current conversion circuit 302b is configured to convert the voltage output by the power module 10 into a voltage required by the chip 301b. The direct current conversion circuit 302c is configured to convert the voltage output by the power module 10 into a voltage required by the chip 301c.

A person of ordinary skill in the art should be aware that the foregoing embodiments are merely used to describe this application, but are not intended to limit this application. Appropriate modifications and variations made to the foregoing embodiments shall fall within the protection scope of this application provided that the modifications and variations fall within the substantive scope of this application.

What is claimed is:

1. A power module, comprising:
a control circuit and a voltage conversion circuit configured to supply power to a load, wherein the control circuit is configured to control the voltage conversion circuit, and the control circuit comprises:
a sampling and amplification circuit configured to: sample a first current output by the voltage conversion circuit, amplify the first current based on a preset coefficient, and output a second current,
a comparison circuit configured to compare the second current with a first overcurrent threshold, and output a first comparison signal when the second current is greater than or equal to the first overcurrent threshold, and
a processing circuit configured to deactivate a pulse signal to the voltage conversion circuit when receiving the first comparison signal to protect the voltage conversion circuit from overcurrent.

2. The power module according to claim 1, wherein
the comparison circuit is further configured to compare the second current with a second overcurrent threshold, and output a second comparison signal when the second current is greater than or equal to the second overcurrent threshold; and
the processing circuit is further configured to:
activate the pulse signal that is output to the voltage conversion circuit within a first time period of one or more switching cycles, and start timing when receiving the second comparison signal at a midpoint moment of the first time period, and
deactivate the pulse signal to the voltage conversion circuit when a timing time reaches a preset time.

3. The power module according to claim 1, wherein
the comparison circuit is configured to compare the second current with a third overcurrent threshold, and output a third comparison signal when the second current is less than the third overcurrent threshold, wherein the third overcurrent threshold is less than the first overcurrent threshold; and
the processing circuit is further configured to stop outputting the pulse signal to the voltage conversion circuit when receiving the third comparison signal.

4. The power module according to claim 2, wherein
the comparison circuit is configured to compare the second current with a third overcurrent threshold, and output a third comparison signal when the second current is less than the third overcurrent threshold, wherein the third overcurrent threshold is less than the first overcurrent threshold; and
the processing circuit is further configured to deactivate the pulse signal to the voltage conversion circuit when receiving the third comparison signal.

5. The power module according to claim 1, wherein
the comparison circuit is further configured to: compare the second current with a fourth overcurrent threshold, and output a fourth comparison signal when the second current is greater than or equal to the fourth overcurrent threshold; and
the processing circuit is further configured to deactivate the pulse signal to the voltage conversion circuit in the one or more switching cycles when receiving the fourth comparison signal.

6. The power module according to claim 2, wherein
the comparison circuit is further configured to compare the second current with a fourth overcurrent threshold, and output a fourth comparison signal when the second current is greater than or equal to the fourth overcurrent threshold; and
the processing circuit is further configured to deactivate the pulse signal to the voltage conversion circuit in the one or more switching cycles when receiving the fourth comparison signal.

7. The power module according to claim 1, wherein
the sampling and amplification circuit comprises an amplifier, a first transistor, a first current source, a second current source, and a third current source, wherein
a first input end of the amplifier is connected to a first output end of the voltage conversion circuit via a first resistor, a second input end of the amplifier is connected to a second output end of the voltage conversion circuit via a second resistor, the first current source is electrically connected to the first resistor and the first input end of the amplifier, an output end of the amplifier is electrically connected to a first end of the first transistor, a second end of the first transistor is electrically connected to the second input end of the amplifier, a third end of the first transistor is electrically connected to the second current source, the third current source is grounded via a third resistor, and a first node between the third current source and the third resistor is connected to the comparison circuit.

8. The power module according to claim 2, wherein
the sampling and amplification circuit comprises an amplifier, a first transistor, a first current source, a second current source, and a third current source, wherein
a first input end of the amplifier is connected to a first output end of the voltage conversion circuit via a first resistor, a second input end of the amplifier is connected to a second output end of the voltage conversion circuit via a second resistor, the first current source is electrically connected to the first resistor and the first input end of the amplifier, an output end of the amplifier is electrically connected to a first end of the first transistor, a second end of the first transistor is electrically connected to the second input end of the amplifier, a third end of the first transistor is electrically connected to the second current source, the third current source is grounded via a third resistor, and a first node between the third current source and the third resistor is connected to the comparison circuit.

9. The power module according to claim 8, wherein
the control circuit further comprises a reference voltage generation circuit that comprises a fourth current source, a fifth current source, and a first voltage source, wherein
a first end of the first voltage source is grounded, a second end of the first voltage source is grounded via a fourth resistor, the second end of the first voltage source is further connected to a power supply via a fifth resistor, the fourth current source is grounded via a sixth resistor, two ends of the sixth resistor are respectively connected to two ends of the fifth current source, the fifth current source is configured to receive a slope compensation reset signal, and a node between the fourth current source and the sixth resistor is electrically connected to the comparison circuit.

10. An electronic device, comprising:
an input power supply; and
a power module, wherein the input power supply is configured to supply power to the power module, the power module comprises a control circuit and a voltage conversion circuit configured to supply power to a load, wherein the control circuit is configured to control the voltage conversion circuit, and the control circuit comprises:
a sampling and amplification circuit configured to sample a first current output by the voltage conversion circuit, amplify the first current based on a preset coefficient, and output a second current,
a comparison circuit configured to compare the second current with a first overcurrent threshold, and output a first comparison signal when the second current is greater than or equal to the first overcurrent threshold, and
a processing circuit configured to deactivate a pulse signal to the voltage conversion circuit when receiving the first comparison signal, to protect the voltage conversion circuit from overcurrent.

11. The electronic device according to claim 10, wherein
the comparison circuit is further configured to compare the second current with a second overcurrent threshold, and output a second comparison signal when the second current is greater than or equal to the second overcurrent threshold; and
the processing circuit is configured to: activate the pulse signal that is output to the voltage conversion circuit within a first time period of one or more switching cycles, and start timing when receiving the second comparison signal at a midpoint moment of the first time period, and
deactivate the pulse signal to the voltage conversion circuit when a timing time reaches a preset time.

12. The electronic device according to claim 10, wherein
the comparison circuit is configured to compare the second current with a third overcurrent threshold, and output a third comparison signal when the second current is less than the third overcurrent threshold, wherein the third overcurrent threshold is less than the first overcurrent threshold; and
the processing circuit is further configured to deactivate the pulse signal to the voltage conversion circuit when receiving the third comparison signal.

13. The electronic device according to claim 11, wherein
the comparison circuit is configured to compare the second current with a third overcurrent threshold, and output a third comparison signal when the second current is less than the third overcurrent threshold, wherein the third overcurrent threshold is less than the first overcurrent threshold; and
the processing circuit is further configured to deactivate the pulse signal to the voltage conversion circuit when receiving the third comparison signal.

14. The electronic device according to claim 10, wherein
the comparison circuit is further configured to compare the second current with a fourth overcurrent threshold, and output a fourth comparison signal when the second current is greater than or equal to the fourth overcurrent threshold; and
the processing circuit is further configured to deactivate the pulse signal to the voltage conversion circuit in the one or more switching cycles when receiving the fourth comparison signal.

15. The electronic device according to claim 11, wherein
the comparison circuit is further configured to compare the second current with a fourth overcurrent threshold, and output a fourth comparison signal when the second current is greater than or equal to the fourth overcurrent threshold; and
the processing circuit is further configured to deactivate the pulse signal to the voltage conversion circuit in the one or more switching cycles when receiving the fourth comparison signal.

16. The electronic device according to claim 10, wherein
the sampling and amplification circuit comprises an amplifier, a first transistor, a first current source, a second current source, and a third current source, wherein
a first input end of the amplifier is connected to a first output end of the voltage conversion circuit via a first resistor, a second input end of the amplifier is connected to a second output end of the voltage conversion circuit via a second resistor, the first current source is electrically connected to the first resistor and the first input end of the amplifier, an output end of the amplifier is electrically connected to a first end of the first transistor, a second end of the first transistor is electrically connected to the second input end of the amplifier, a third end of the first transistor is electrically connected to the second current source, the third current source is grounded via a third resistor, and a first node between the third current source and the third resistor is connected to the comparison circuit.

17. The electronic device according to claim 11, wherein
the sampling and amplification circuit comprises an amplifier, a first transistor, a first current source, a second current source, and a third current source, wherein
a first input end of the amplifier is connected to a first output end of the voltage conversion circuit via a first resistor, a second input end of the amplifier is connected to a second output end of the voltage conversion circuit via a second resistor, the first current source is electrically connected to the first resistor and the first input end of the amplifier, an output end of the amplifier is electrically connected to a first end of the first transistor, a second end of the first transistor is electrically connected to the second input end of the amplifier, a third end of the first transistor is electrically connected to the second current source, the third current source is grounded via a third resistor, and a first node between the third current source and the third resistor is connected to the comparison circuit.

18. The electronic device according to claim 16, wherein
the control circuit further comprises a reference voltage generation circuit, the reference voltage generation circuit comprises a fourth current source, a fifth current source, and a first voltage source, wherein
a first end of the first voltage source is grounded, a second end of the first voltage source is grounded via a fourth resistor, the second end of the first voltage source is further connected to a power supply via a fifth resistor, the fourth current source is grounded via a sixth resistor, two ends of the sixth resistor are respectively connected to two ends of the fifth current source, the fifth current source is configured to receive a slope compensation reset signal, and a node between the fourth current source and the sixth resistor is electrically connected to the comparison circuit.

19. The electronic device according to claim 17, wherein
the control circuit further comprises a reference voltage generation circuit, the reference voltage generation circuit comprises a fourth current source, a fifth current source, and a first voltage source, wherein
a first end of the first voltage source is grounded, a second end of the first voltage source is grounded via a fourth resistor, the second end of the first voltage source is further connected to a power supply via a fifth resistor, the fourth current source is grounded via a sixth resistor, two ends of the sixth resistor are respectively connected to two ends of the fifth current source, the fifth current source is configured to receive a slope compensation reset signal, and a node between the fourth current source and the sixth resistor is electrically connected to the comparison circuit.

20. A router, comprising:
one or more chips; and
a power module connected to supply power to the one or more chips, wherein the power module comprises:
a control circuit and a voltage conversion circuit configured to supply power to a load, wherein the control circuit is configured to control the voltage conversion circuit, and the control circuit comprises:
a sampling and amplification circuit configured to sample a first current output by the voltage conversion circuit, amplify the first current based on a preset coefficient, and output a second current;
a comparison circuit is configured to compare the second current with a first overcurrent threshold, and output a first comparison signal when the second current is greater than or equal to the first overcurrent threshold; and
a processing circuit is configured to deactivate a pulse signal to the voltage conversion circuit when receiving the first comparison signal, to protect the voltage conversion circuit from overcurrent.
